(19) United States
(12) Patent Application Publication
(10) Pub. No.: US 2016/0180287 A1
(43) Pub. Date: Jun. 23, 2016

(54) SYSTEMS AND METHODS FOR MODIFYING PACKAGE DELIVERY CHARACTERISTICS

(71) Applicant: Elwha LLC, Bellevue, WA (US)

(72) Inventors: Alistair K. Chan, Bainbridge Island, WA (US); Roderick A. Hyde, Redmond, WA (US); Tony S. Pan, Bellevue, WA (US); Lowell L. Wood, JR., Bellevue, WA (US)

(73) Assignee: ELWHA LLC, Bellevue, WA (US)

(21) Appl. No.: 14/577,758

(22) Filed: Dec. 19, 2014

(51) Int. Cl. G06Q 10/08; G06Q 20/10; G06Q 40/08; G06Q 30/02

(52) U.S. Cl. CPC G06Q 10/0833; G06Q 30/0255; G06Q 30/0226; G06Q 20/10; G06Q 40/08

(57) ABSTRACT

Systems and methods for providing customer requested shipping levels-of-service changes directly via a shipping company and independent of the merchant that sold the goods are described. During an online shopping transaction, a customer purchases goods from a merchant via the merchant's website. After the purchase is complete, the customer can directly interact with the shipping company to change the level-of-service of the shipment. The customer may request that a higher or lower level-of-service be used in delivering the goods. In exchange, the shipping company will require payment from the customer or return payment back to the customer. The payment may be in the form of money or loyalty points with the shipping company.

### BACKGROUND

Online shopping allows customers to purchase goods from merchants over the internet. The purchased goods are then delivered to the customers from the merchant, the merchant's warehouses, third-party warehouses, or directly from a manufacturer. The purchased goods are typically delivered or shipped by a shipping company. In some situations, a merchant may have negotiated a standard shipping service (e.g., 2-day delivery service, 3-day delivery service, etc.) with a particular shipping company, and most goods purchased from the merchant are shipped via the standard shipping service. In further arrangements, the merchant may provide the customer the option of paying more for expedited shipping or another more premium shipping service (e.g., in home delivery and installation). However, after the initial shipping service is selected during the purchase process, the customer may later decide that he needs the package sooner, does not need the package as quickly, no longer requires insurance, or the like.

### SUMMARY

One embodiment relates to a method of adjusting a shipping level-of-service for a shipment. The method includes receiving, at a shipping company computing system from a merchant computing system, a shipping request including an initial shipping level-of-service for the shipment, wherein the shipping company computing system is associated with a shipping company hired to deliver the shipment. The method further includes sending, by the shipping company computing system, tracking information to a customer computing device, wherein the tracking information includes a unique tracking number associated with the shipment. The method includes receiving, by the shipping company computing system and from the customer computing device, a request to modify the initial shipping level-of-service for the shipment to a second shipping level-of-service. The method further includes dispatching, by the shipping company computing system, updated shipping instructions to a delivery agent in accordance with the second shipping level-of-service.

Another embodiment relates to a method of operating a lottery funded with shipping cost savings. The method includes receiving, by a shipping company computing system, a plurality of requests to downgrade shipping levels-of-service associated with a plurality of different shipments. The method further includes receiving, by the shipping company computing system, a plurality of elections from a plurality of customers associated with the plurality of requests to contribute cost savings associated with the downgrades to a lottery pool. The method includes funding, by the shipping company computing system, the lottery pool with cost savings associated with the downgrades. The method further includes distributing, by the shipping company computing system, a plurality of lottery entries to the plurality of customers. The method includes determining, by the shipping company computing system, a winning lottery entry from the plurality of lottery entries. The method further includes providing, by the shipping company computing system, a payment to a winning customer of the plurality of customers, wherein the winning customer is associated with the winning lottery entry.

Yet another embodiment relates to a shipping company computing system associated with a shipping company hired to deliver a shipment. The system includes a memory, a network interface configured to provide data communication with a merchant computing system and a customer computing device over a network, and a processor. The processor is configured to receive a shipping request including an initial shipping level-of-service for the shipment from the merchant computing system. The processor is further configured to send tracking information to the customer computing device, wherein the tracking information includes a unique tracking number associated with the shipment. The processor is configured to receive a request to modify the initial shipping level-of-service for the shipment to a second shipping level-of-service from the customer computing device. The processor is further configured to dispatch updated shipping instructions to a delivery agent in accordance with the second shipping level-of-service.

Another embodiment relates to a non-transitory computer-readable media having computer-executable instructions embodied therein that, when executed by a processor of a shipping company computing system, cause the processor to perform a method of adjusting a shipping level-of-service for a shipment. The instructions cause the processor to receive a shipping request including an initial shipping level-of-service for the shipment from a merchant computing system. The instructions further cause the processor to send tracking information to a customer computing device, wherein the tracking information includes a unique tracking number associated with the shipment. The instructions cause the processor to receive a request to modify the initial shipping level-of-service for the shipment to a second shipping level-of-service from the customer computing device. The instructions further cause the processor to dispatch updated shipping instructions to a delivery agent in accordance with the second shipping level-of-service.

A further embodiment relates to a shipping company computing system associated with a shipping company hired to deliver shipments from a merchant. The system includes a memory, a network interface configured to provide data communication with a merchant computing system and a plurality of customer computing devices over a network, and a processor. The processor is configured to receive a plurality of requests to downgrade shipping levels-of-service associated with a plurality of different shipments. The processor is further configured to receive a plurality of elections from a plurality of customers associated with the plurality of requests to contribute cost savings associated with the downgrades to a lottery pool. The processor is configured to fund the lottery pool with cost savings associated with the downgrades. The processor is further configured to distribute a plurality of lottery entries to the plurality of customers, and to determine a winning lottery entry from the plurality of lottery entries. The processor is configured to provide a payment to a winning customer of the plurality of customers, wherein the winning customer is associated with the winning lottery entry.

Another embodiment relates to a non-transitory computer-readable media having computer-executable instructions embodied therein that, when executed by a processor of a shipping company computing system, cause the processor to perform a method of operating a lottery funded with shipping cost savings. The instructions cause the processor to receive a plurality of requests to downgrade shipping levels-of-service associated with a plurality of different shipments. The instructions further cause the processor to receive a plurality of elections from a plurality of customers associated with the plurality of requests to contribute cost savings associated with the downgrades to a lottery pool. The instructions cause the processor to fund the lottery pool with cost savings associated with the downgrades. The instructions further cause the processor to distribute a plurality of lottery entries to the plurality of customers. The instructions cause the processor to determine a winning lottery entry from the plurality of lottery entries. The instructions further cause the processor to provide a payment to a winning customer of the plurality of customers, wherein the winning customer is associated with the winning lottery entry.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram of a computer system according to an embodiment.

FIG. 2 is a flow diagram of a method of adjusting a shipping level-of-service for an already dispatched shipment according to an embodiment.

FIG. 3 is a user-interface of a shipping company's website as viewed on a customer device according to an embodiment.

FIG. 4 is a user-interface of a shipping company's website as viewed on a customer device according to an embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring to the figures generally, systems and methods for providing customer requested shipping levels-of-service changes directly via a shipping company and independent of the merchant that sold the goods are described. During an online shopping transaction, a customer purchases goods from a merchant via the merchant's website. In some arrangements, the merchant has already negotiated shipping options with a shipping company that ultimately delivers the purchased goods from the merchant to the customer. The customer may have the option to adjust the level-of-service provided from the shipping company through the merchant's website at the time of purchase. The term “level-of-service” refers to the characteristics of the shipping service (e.g., delivery time, delivery service type, insurance, etc.). For example, a higher level-of-service may provide a faster delivery time than a lower level-of-service. The higher level-of-service typically costs more than the lower level-of-service.

In addition to interacting with the merchant at the time of the purchase, the customer may also directly interact with the shipping company to change the level-of-service after the purchase is completed with the merchant. Once the purchase is completed and the goods to be delivered are already with or under the responsibility of the shipping company, the customer may contact the shipping company to request that a higher or lower level-of-service be used in delivering the goods. For example, the customer may have initially selected a three business day shipping option at the time of purchase and now desires a next-day level-of-service. In this example, the customer may contact the shipping company directly to upgrade the level-of-service from the three-day service to the next-day service. In exchange, the shipping company will require payment from the customer. The payment may be in the form of money, an existing credit with the shipping company (e.g., accumulated loyalty points), a waiver of rights held by the customer (e.g., waiver of warranty rights associated with the shipment, waiver of shipping insurance, making the transaction non-refundable, etc.), an agreement by the customer to receive downgraded shipping on a set number of future shipments, an agreement by the customer to view advertisements (e.g., stickers placed on the outside of the shipment packaging, fliers placed within shipment packaging, etc.), and the like. In another example, the customer may have initially selected a next-day level of service for shipping the goods and now does not need the goods as quickly. In this example, the customer may contact the shipping company directly to downgrade the level-of-service from the next-day service to the three-day service. In exchange, the shipping company may provide a benefit to the customer (e.g., payment of money, payment of loyalty points, upgraded shipping level-of-service credits for future shipments, improving the warranty rights associated with the shipment, increasing the insurance value associated with the shipment, making the shipment transaction refundable or refundable for a longer period of time, including return shipping, opting the customer out of advertisements associated with the shipment, and the like.

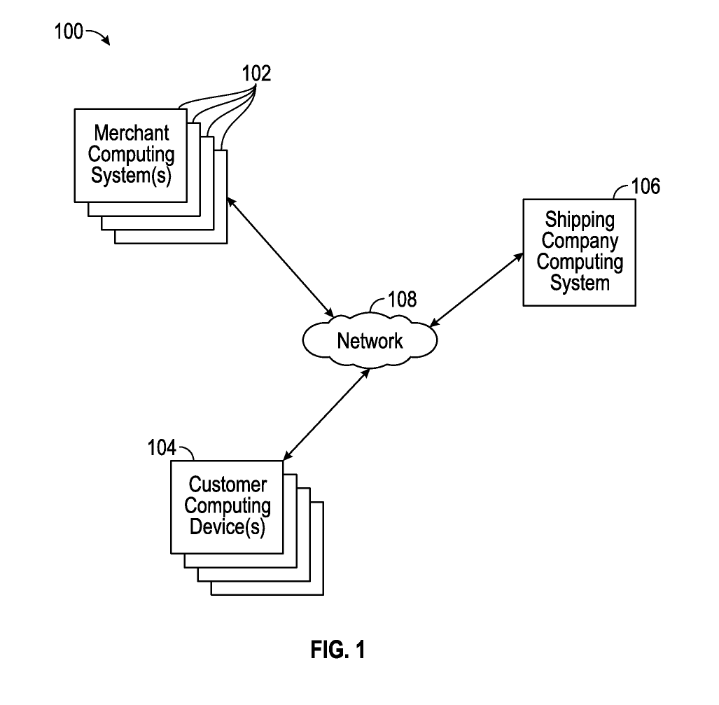

Referring to FIG. 1, a block diagram of computer system 100 is shown according to an embodiment. Computing system 100 includes at least one merchant computing system 102. As shown in FIG. 1, computing system 100 includes a plurality of merchant computing systems 102. Each of the merchant computing systems 102 is associated with a different merchant (e.g., a first merchant computing system is associated with a first merchant, a second merchant computing system is associated with a second merchant, and so on). A merchant is a retailer that hosts a website where customers can purchase goods that are later shipped to the customers. In some arrangements, a merchant may also operate a brick-and-mortar store location. Merchant computing systems 102 include computing components (e.g., a backend server having a processor, memory, and a network interface) necessary to provide the goods to customers and to arrange for shipping of any purchased items to customers. In some arrangements, merchant computing systems 102 include website servers that host retailer websites where customers can purchase goods that are shipped by the merchants to the customers.

Customers of the merchants interact with the merchant computing systems 102 using customer devices 104. Customer devices 104 include customer computing devices such as smartphones, media devices, laptop computers, tablet computers, desktop computers, and the like. Customer devices 104 include applications that directly interact with merchant computing systems 102 (e.g., smartphone applications) to allow customers to purchase goods from the merchants, web browsers that allow customers to access merchant websites to purchase goods, or a combination thereof.

Merchants coordinate the shipment of purchased goods to customers via a third-party shipping company. Merchant computing systems 102 are in communication with shipping company computing system 106 associated with the third-party shipping company. Shipping company computing system 106 may include a backend server associated with the third-party shipping company. In some arrangements, shipping company computing system 106 includes a website server that hosts a website accessible by the customers and merchants. Although only a single shipping company computing system 106 is shown, a plurality of different shipping company computing systems 106 associated with a plurality of different third-party shipping companies may exist in system 100. The third-party shipping company receives the goods purchased by the customers from any of the merchants and delivers the purchased goods to the customers. The third-party shipping company offers a plurality of different levels-of-service for delivering the goods. In some arrangements, certain merchants pre-negotiate levels-of-service that are available to the customers. In other arrangements, certain merchants allow customers to designate specific levels-of-service offered by the third-party shipping companies at the time of the purchase of the goods. As described in further detail below, customers can also alter the initial level-of-service for a shipment of purchased goods to be shipped by the third-party shipping company by directly interacting with the third-party shipping company after the purchase is made.

Merchant computing systems 102, customer computing devices 104, and shipping company computer system 106 each communicate with each other via network 108. Each of the merchant computing systems 102, customer computing devices 104, and shipping company computing system 106 includes a network interface that allows for data communication over network 108. In some arrangements, network 108 includes the internet.

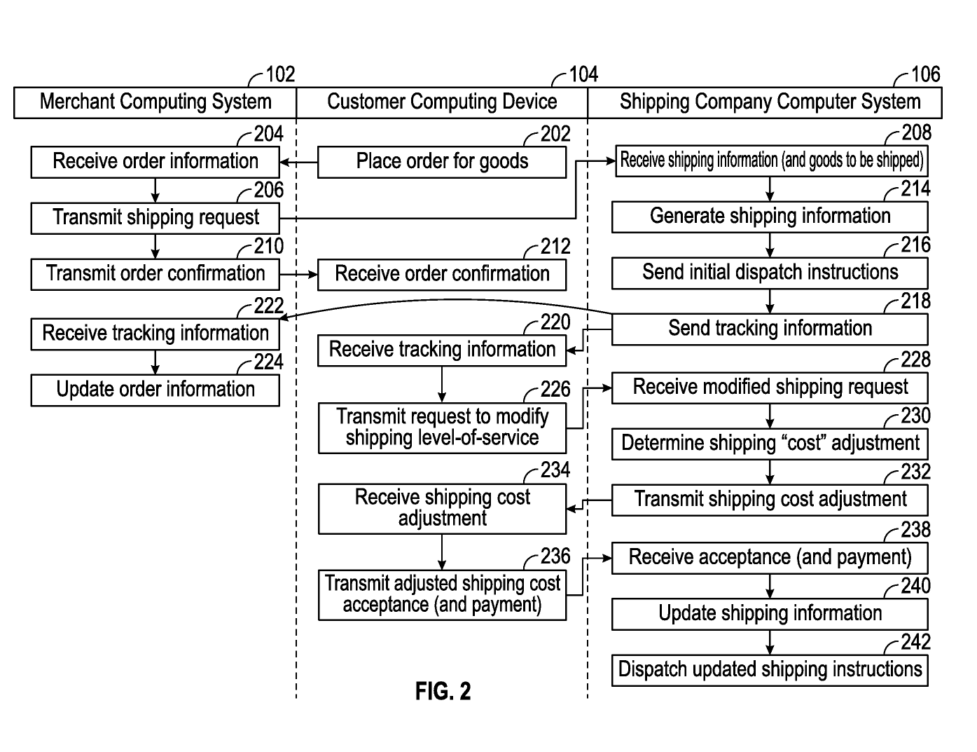

Referring to FIG. 2, a flow diagram of method 200 of adjusting a shipping level-of-service for a shipment (e.g., an already-dispatched shipment) is shown according to an embodiment. The flow diagram of FIG. 2 provides a visual diagram of the interaction between merchant computing system 102, customer computing device 104, and shipping company computing system 106 during a typical purchase and shipping of goods where the shipping level-of-service is adjusted after the purchase and/or initial dispatch of the purchased goods. Merchant computing system 102, customer computing device 104, and shipping company computing system 106 communicate over a network (e.g., network 108, the internet, etc.). In some arrangements, the negotiation between the customer and the shipping company is facilitated by a third party service (e.g., a third party negotiation service that operates a third party computer system in communication with the customer computing device 104 and the shipping company computing system 106).

Method 200 begins when a customer places an order for goods to be shipped (202). The order is placed by a customer via customer computing device 104. The order is for goods purchased from a merchant associated with merchant computing system 102. The goods will be shipped from the merchant to the customer by a shipping company associated with shipping company computing system 106. In some arrangements, the order is placed via a merchant website accessed via customer computing device 104. In other arrangements, the order is placed via a merchant application running on customer computing device 104. The order information is received by the merchant (204). The order is received at merchant computing system 102. Merchant computing system 102 completes the order (e.g., locates the purchased goods, bills the customer for the purchased goods, orders goods from a supplier if the goods are not in stock, etc.). In some arrangements, the order information includes initial shipping information, such as an initial shipping level-of-service selected by the customer. In other arrangements, the initial shipping level-of-service is prearranged by the merchant (e.g., all goods purchased from the merchant are shipped via a standard shipping level-of-service).

After the order information is received, a shipping request is transmitted (206). The shipping request is transmitted from merchant computing system 102 to shipping company computing system 106. The shipping request includes information from the merchant relating to the goods (i.e., the shipment) to be shipped by the shipping company. For example, the shipping request may include information such as the size of the packaging containing the goods to be shipped, the initial shipping level-of-service, a pickup location or address, a shipping location (e.g., the customer's address), and any other information about the shipment. The shipping request is received (208). The shipping request is received at shipping company computing system 106.

An order confirmation is transmitted (210). The order confirmation is transmitted by merchant computing system 102. The order confirmation is received (212) by customer computing device 104. The order confirmation includes details about the order for the goods. The order confirmation may include any of an order number, a payment confirmation (including an amount paid by the customer for the goods and any delivery fees), an estimated delivery time, an indication that a shipping request was sent to the shipping company, a description of the goods, and the like. The order confirmation may be received in the form of an e-mail, an application message (e.g., a push notification in a merchant application running on customer computing device 104), or a combination thereof.

Shipping information is generated (214). The shipping information is generated by shipping company computing system 106. The shipping information includes initial dispatch instructions (e.g., instructions to a local vehicle to pick up the goods to be shipped from the pickup address, an indication of the initial level-of-service, the delivery address, etc.) and tracking information. The tracking information includes a unique tracking number associated with each of the packages of goods to be delivered. For example, in some situations, a customer orders multiple goods from the same merchant, which are shipped in individual packages. Each package being shipped receives a unique tracking number. The tracking numbers of the packages may be used by the merchant, the customer, or the shipping company to locate the locations of the packages throughout the shipping process (e.g., at the merchant warehouse waiting to be picked up, at a shipping company warehouse, on a shipping company vehicle, delivered to the delivery address, etc.).

The initial dispatch instructions are sent (216). The initial dispatch instructions are sent by shipping company computing system 106 to an employee or contractor of the shipping company. For example, the initial dispatch instructions may be sent to a mobile device of a driver, an employee, a contractor, or an agent of the shipping company that is located in the vicinity of the shipment origination location (e.g., a merchant's warehouse). The initial dispatch instructions include an instruction to pick up the goods from the origination location. Prior to sending the initial dispatch instructions, shipping company computing system 106 may identify the driver as the closest driver, employee, contractor or agent to the origination location out of a plurality of available drivers, employees, contractors, and agents.

Tracking information is sent (218). Tracking information is sent by shipping company computing system 106. The tracking information includes any tracking numbers associated with the shipment of goods. The tracking information is received (220) at customer computing device 104. The tracking information may be received via an e-mail message, a push notification, or the like. In some arrangements, the tracking information is also sent to the merchant. Accordingly, tracking information may also be received by merchant computing system 102 (222). The tracking information may be associated with internal records of the merchant relating to the order for goods by the customer. In such arrangements, the order information accessible by the customer via the merchant's website or application is updated to reflect the shipping information (224).

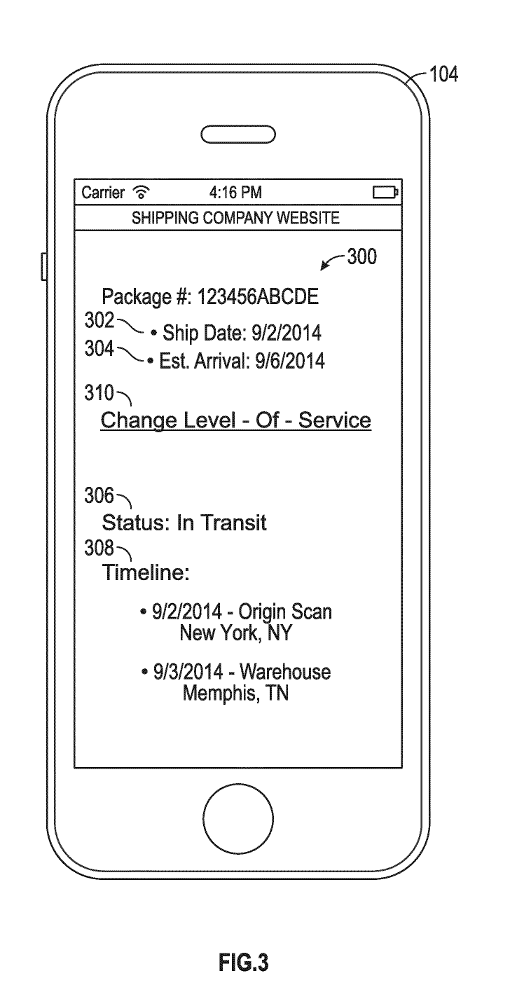

The tracking numbers within the tracking information can be used by the customer to look-up the status of packages in route from the merchant to the customer on the shipping company's website. For example, as shown in FIG. 3, a user-interface 300 of the shipping company's website as viewed on customer device 104 (shown as a smartphone) is shown according to an embodiment. User-interface 300 shows package tracking information for a specific package having tracking number “123456ABCDE.” User-interface 300 tells the customer that the package shipped on Sep. 2, 2014 (“Ship Date” 302) and is expected to arrive at its destination on Sep. 6, 2014 (“Est. Arrival” 304). Details on the package's transit are shown in package status section 306 and in timeline 308. User-interface 300 includes a “change level-of-service” button 310 (e.g., a selectable icon, etc.) that the customer can interact with to change the shipping level-of-service for the displayed package. Referring again to FIG. 2, in some arrangements, the received tracking information can include an advertisement to the customer to change the level-of-service of the package in route from the merchant to the customer. This advertisement can include information on available level-of-service options, on available changes in level-of-service, on cost-adjustments associated with a change in the level-of-service, on an amount of shipping loyalty points in the customer's account, and the like.

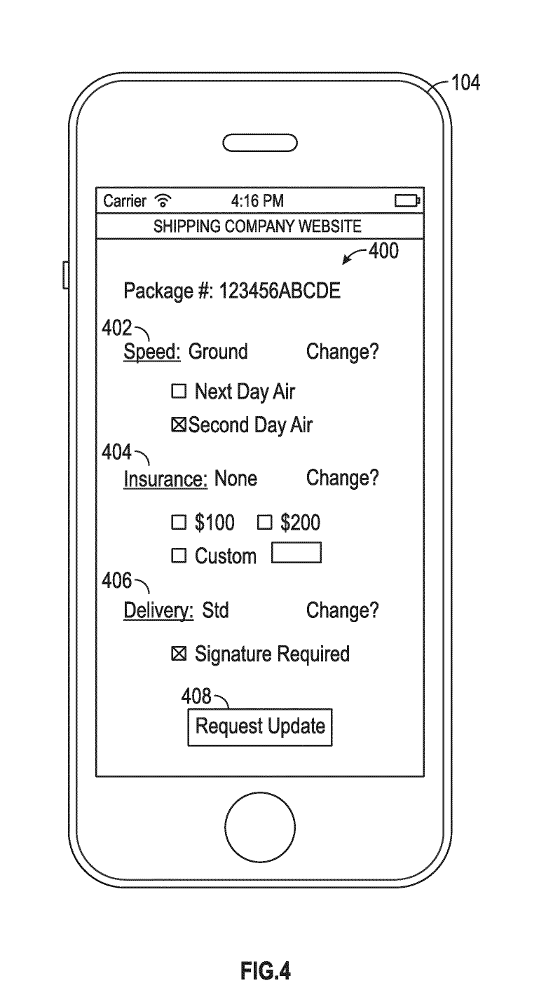

Referring to FIG. 4, a user-interface 400 of the shipping company's website as viewed on customer device 104 is shown according to an embodiment. A customer is presented with user-interface 400 after the customer interacts with button 310. User-interface 400 allows the customer to update the shipping level-of-service. User-interface 400 allows the customer to upgrade or downgrade a shipping speed 402 (e.g., increase or decrease the delivery speed), adjust an insurance amount 404 (e.g., increase or decrease an amount of insurance on the package), and change a delivery type 406. Depending on the shipping company, more or fewer shipping parameters may be changed after the package's initial dispatch. Additional shipping parameters may include a destination address (e.g., a different address of the customer, the shipping company warehouse for customer pick-up, etc.), a method of delivery (e.g., ground, airplane, drone, an environmentally friendly or “green” mode of delivery, etc.), and the like. In the situation shown in FIG. 4, the customer selected to accelerate delivery from a ground delivery to a second day air deliver, and the customer selected to change from no signature required to signature required on delivery. The customer can request the update with the shipping company by interacting with “request update” button 408.

Referring again to FIG. 2, a request to modify the shipping level-of-service is transmitted (226). The request is transmitted from customer computing device 104 to shipping company computing system 106 (e.g., based on a customer's input in user interface 400). The request may be transmitted through customer interaction with the shipping company's website (e.g., as discussed above with respect to FIG. 4). The request includes updated shipping level-of-service shipping parameters (e.g., an updated shipping speed, an adjusted shipping insurance amount, an updated delivery type, etc.). The modified shipping level-of-service request is received (228). The request is received at shipping company computing system 106.

A shipping cost adjustment is determined (230). The shipping company computing system 106 determines whether the cost of the updated shipping level-of-service is different than the cost of the initial level-of-service. In some arrangements, the updated shipping level-of-service is more expensive than the initial level-of-service. For example, if a customer requests a faster speed of shipping (e.g., changing the initial ground shipping speed to a faster next-day air shipping speed), the shipping company may require the customer to remit additional payment to effect the change in level-of-service. The customer may remit payment to the shipping company in fiat currency (e.g., dollars via a credit card, an e-check, etc.), math-based currency (e.g., Bitcoin), accumulated shipping loyalty points (e.g., points received for purchases, as gift cards, for prior downgrades in levels-of-service, etc.), or a combination thereof. Alternatively, the customer may agree to waive or reduce certain rights (e.g., waiver of warranty rights associated with the shipment, waiver of shipping insurance, making the transaction non-refundable, etc.) associated with the shipment, agree to receive downgraded levels-of-service for a designated number of future shipments, or agree to receive advertisements (e.g., stickers placed on the outside of the shipment packaging, fliers placed within shipment packaging, etc.) to “pay” for the shipping cost differential. In other arrangements, the updated shipping level-of-service is less expensive than the initial level-of-service. For example, if a customer requests a slower speed of shipping (e.g., changing the initial next-day air shipping speed to a slower ground shipping speed), the shipping company may refund payment in updating the level-of-service. The shipping company may refund the payment in fiat currency, math-based currency, shipping loyalty points, or a combination thereof. The shipping company may offer the customer a higher number of loyalty points than fiat currency or math-based currency to encourage the customer to accumulate loyalty points. Alternatively, the customer may agree to receive upgraded shipping level-of-service credits for future shipments, to improve the warranty rights associated with the shipment, increase the insurance value associated with the shipment, to make the shipment transaction refundable or refundable for a longer period of time, to receive return shipping, or to opt out of advertisements associated with the shipment as satisfaction for the cost difference between the original level-of-service and the downgraded level-of-service. The loyalty points may be associated with a customer account with the shipping company. In some arrangements, customers can purchase, trade, and sell loyalty points to or with other customers or with the shipping company. The customer can use accumulated loyalty points to pay for future shipments, to purchase higher levels-of-service on future shipments, to purchase other goods (e.g., through a catalog of rewards purchased with loyalty points). In other arrangements, the shipping company refunds payment by making a donation to a charity. The donation may be in the customer's name. The shipping company may offer to match the donation.

In yet another arrangement, the shipping company can refund payments to customers by providing a lottery ticket to the customers. Any given individual refund for an individual shipment change may be relatively small. For example, if a customer downgrades from two-day air delivery to ground deliver, the downgrade may only result in a refund of one dollar. However, during normal operation, the shipping company can process a plurality of requests to downgrade shipping levels-of-service for a plurality of different shipments. The aggregate refund for the plurality of downgrades will total a larger sum of money. For example, the refunds associated with one thousand customers may total a larger sum, such as one thousand dollars. In such an arrangement, each customer has the option to forgo an individual refund and to opt into a lottery for a larger sum of money from a pool formed of a plurality of refunds of those that opt into the lottery. Each customer that opts into the lottery receives a lottery ticket for a given pool of money. The shipping company distributes lottery tickets to the customers that opt into the lottery. The lottery tickets may be distributed electronically by the shipping company computing system 106 or as printed tickets sent through the mail. The pool of money is funded by the refund deferrals (e.g., the cost savings associated with each downgraded shipment) for all customers that opt into the lottery instead of receiving an individual refund. The lottery may be a geographic specific lottery (e.g., the pool of funds for the geographic specific lottery is only funded by refund deferrals for a given geographic region, such as a state, a city, a country, a county, etc.). The lottery may be a time-limited lottery that accumulates funds in the pool for a predetermined time period (e.g., refunds deferred for one week, for two weeks, for one month, for a year, etc.) and is awarded after the predetermined time period has expired. The pool may be funded until a designated number of lottery tickets or entrants (e.g., a designated number of participants) has been reached. The shipping company may earn interest on the deferred refunds. In some arrangements, the shipping company may take a percentage as a fee for running the lottery. The shipping company distributes lottery tickets (e.g., paper lottery tickets, digital lottery tickets) to the customers that opt into the lottery. The shipping company then performs periodic drawings to determine the winners of the lottery. The winners of the lottery are awarded funds from the pool. In some embodiments, the funds provided to the lottery winner may comprise money (i.e., cash or other forms of currency), future lottery entries, shipping loyalty points, future shipping services (de-novo or upgrades), or the like.

The determined shipping cost adjustment is transmitted (232). The shipping cost adjustment is transmitted from shipping company computing system 106 to customer computing device 104. The shipping cost adjustment is transmitted with an acceptance request. The shipping cost adjustment is received (234). The shipping cost adjustment is received at customer computing device 104. The shipping cost adjustment may be displayed on a user interface (e.g., via the shipping company's website) along with the acceptance request. An acceptance of the updated shipping cost along with any required payment is transmitted (236). The acceptance of the updated shipping cost and any required payment is transmitted from customer computing device 104. Although shown as receiving acceptance and payment (e.g., when the customer is upgrading the initial level-of-service to a higher level-of-service), the shipping company can also refund the customer if a downgrade in level of service is requested (e.g., as described above in situations where the updated shipping level-of-service is less expensive than the initial level-of-service).

Still referring to FIG. 2, the acceptance and payment is received (238). The acceptance and payment is received by shipping company computing system 106. Shipping information relating to the package is updated (240). Shipping company computing system 106 updates the information relating to the package to include the updated level-of-service. Updated shipping instructions are dispatched (242). The updated shipping instructions, including the updated level-of-service, are dispatched by shipping company computing system 106. The updated shipping instructions may be sent to a computing device associated with an employee, agent, or contractor of the shipping company in possession of the package (e.g., a delivery agent of the shipping company). For example, the updated shipping instructions may be sent to a mobile device of a driver of the vehicle having the package on board.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Accordingly, all such modifications are intended to be included within the scope of the present inventions. The order or sequence of any process or method steps may be varied or re-sequenced according to alternative embodiments. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

1. A method of adjusting a shipping level-of-service for a shipment, the method comprising:
receiving, at a shipping company computing system from a merchant computing system, a shipping request including an initial shipping level-of-service for the shipment, wherein the shipping company computing system is associated with a shipping company hired to deliver the shipment;
sending, by the shipping company computing system, tracking information to a customer computing device, wherein the tracking information includes a unique tracking number associated with the shipment;
receiving, by the shipping company computing system and from the customer computing device, a request to modify the initial shipping level-of-service for the shipment to a second shipping level-of-service;
dispatching, by the shipping company computing system, updated shipping instructions to a delivery agent in accordance with the second shipping level-of-service;
determining, by the shipping company computing system, a cost adjustment amount associated with the request to modify the initial shipping level-of-service, wherein the second shipping level of service is more expensive than the initial shipping level-of-service; and
receiving a payment from the customer prior to dispatching the updated shipping instructions, wherein the payment includes an agreement by the customer to at least one of waive rights associated with the shipment, receive downgraded shipping on a set number of future shipments, or receive advertisements with the shipment.

2. The method of claim 1, further comprising sending, by the shipping company computing system, an advertisement to a customer computing device, wherein the advertisement includes one or more options associated with modifying the initial shipping level-of-service for the shipment to a second shipping level-of-service.

3-26. (canceled)

27. The method of claim 1, further comprising sending, by the shipping company computing system, initial dispatch instructions associated with the shipment to a mobile device of a driver, wherein the initial dispatch instructions include an instruction to pick up the shipment from a shipment origination location.

28. The method of claim 27, further comprising identifying, by the shipping company computing system, the driver as the closest driver to the shipment origination location from a plurality of available drivers prior to sending the initial dispatch instructions.

29-38. (canceled)

39. A shipping company computing system associated with a shipping company hired to deliver a shipment, the system comprising:
a memory;
a network interface configured to provide data communication with a merchant computing system and a customer computing device over a network; and
a processor configured to:
receive a shipping request including an initial shipping level-of-service for the shipment from the merchant computing system,
send tracking information to the customer computing device, wherein the tracking information includes a unique tracking number associated with the shipment,
receive a request to modify the initial shipping level-of-service for the shipment to a second shipping level-of-service from the customer computing device,
dispatch updated shipping instructions to a delivery agent in accordance with the second shipping level-of-service,
determine a cost adjustment amount associated with the request to modify the initial shipping level-of-service, wherein the second shipping level of service is more expensive than the initial shipping level-of-service; and
receive a payment from the customer prior to dispatching the updated shipping instructions, wherein the payment includes an agreement by the customer to at least one of waive rights associated with the shipment, receive downgraded shipping on a set number of future shipments, or receive advertisements with the shipment.

40-53. (canceled)

54. The system of claim 39, wherein the request to modify the initial shipping level-of-service includes a request to increase a delivery speed of the shipment.

55. The system of claim 39, wherein the request to modify the initial shipping level-of-service includes a request to decrease a delivery speed of the shipment.

56. The system of claim 39, wherein the request to modify the initial shipping level-of-service includes a request to adjust an insurance amount associated with the shipment.

57. The system of claim 39, wherein the request to modify the initial shipping level-of-service includes a request to change a delivery address associated with the shipment.

58. The system of claim 39, wherein the request to modify the initial shipping level-of-service includes a request to modify an insurance coverage associated with the shipment.

59. The system of claim 39, wherein the request to modify the initial shipping level-of-service includes a request to require a signature upon delivery of the shipment.

60-66. (canceled)

67. A non-transitory computer-readable media having computer-executable instructions embodied therein that, when executed by a processor of a shipping company computing system, cause the processor to:
receive a shipping request including an initial shipping level-of-service for the shipment from a merchant computing system,
send tracking information to a customer computing device, wherein the tracking information includes a unique tracking number associated with the shipment,
receive a request to modify the initial shipping level-of-service for the shipment to a second shipping level-of-service from the customer computing device,
dispatch updated shipping instructions to a delivery agent in accordance with the second shipping level-of-service,
determine a cost adjustment amount associated with the request to modify the initial shipping level-of-service, wherein the second shipping level-of-service is more expensive than the initial shipping level-of-service,
receive a payment from the customer prior to dispatching the updated shipping instructions, wherein the payment includes accumulated loyalty points associated with the customer, an agreement by the customer to waive rights associated with the shipment, to receive downgraded shipping on a set number of future shipments, or to receive advertisements with the shipment.

68-114. (canceled)
